(19) United States
(12) Patent Application Publication
(10) Pub. No.: US 2007/0210964 A1
(43) Pub. Date: Sep. 13, 2007

(54) Antenna including loop and single-pole antenna members interconnected by an inductor

(75) Inventors: Tiao-Hsing Tsai, Tao Yuan Shien (TW); Chao-Chiang Kuo, Tao Yuan Shien (TW); Ying-Chih Wang, Tao Yuan Shien (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Quanta Computer Inc., Tao Yuan Shien (TW)

(21) Appl. No.: 11/442,368

(22) Filed: May 25, 2006

(30) Foreign Application Priority Data
Mar. 10, 2006 (TW) 095108115

(51) Int. Cl. H01Q 1/38

(52) U.S. Cl. 343/700 MS; 343/770; 343/866

(57) ABSTRACT

An antenna includes loop and single-pole antenna members, and an inductor. The single-pole antenna member is spaced apart from the loop antenna member. The inductor has a first inductor terminal coupled to the loop antenna member, and a second inductor terminal coupled to the single pole antenna member. A desired resonance frequency of the antenna can be achieved by simply adjusting the inductance of the inductor.

### CROSS-REFERENCE TO RELATED APPLICATION

This application claims priority of Taiwanese application no. 095108115, filed on Mar. 10, 2006.

### BACKGROUND OF THE INVENTION

1. Field of the Invention

The invention relates to an antenna, more particularly to an antenna that includes loop and single-pole antenna members interconnected by an inductor.

2. Description of the Related Art

FIG. 1 illustrates a conventional antenna that is applied to a clamshell-type mobile phone (not shown) The antenna includes a loop antenna member 10 and a single-pole antenna member 11 that are made from a copper foil and that are formed on a substrate 1. The loop antenna member 10 has opposite first and second end portions 100, 101. The first end portion 100 of the loop antenna member 10 serves as a feeding terminal, and receives a signal that is to be transmitted. The second end portion 101 of the loop antenna member 10 serves as a grounding terminal, and is coupled to a circuit board (not shown). The single-pole antenna member 11 extends and turns from the first end portion 100 of the loop antenna member 10.

The aforementioned conventional antenna is disadvantageous in that the physical length of the single-pole antenna member 11 has to be adjusted when it is desired to operate the conventional antenna at different frequency ranges. The conventional antenna is further disadvantageous in that the single-pole antenna member 11 exceeds five millimeters of its initial length when operated from an initial frequency range to another frequency range, thereby resulting in a relatively large size for the conventional antenna.

### SUMMARY OF THE INVENTION

Therefore, the object of the present invention is to provide an antenna that can overcome the aforesaid drawbacks of the prior art.

According to the present invention, an antenna comprises loop and single-pole antenna members, and an inductor. The single-pole antenna member is spaced apart from the loop antenna member. The inductor has a first inductor terminal coupled to the loop antenna member, and a second inductor terminal coupled to the single pole antenna member.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic view of a conventional antenna;

FIG. 2 is a fragmentary schematic view of the preferred embodiment of an antenna according to the present invention;

FIG. 3 is a plot to illustrate voltage standing wave ratio (VSWR) of the preferred embodiment and the conventional antenna in a frequency range from 0.7 GHz to 2.3 GHz;

FIG. 4 is another plot to illustrate voltage standing wave ratio (VSWR) of the preferred embodiment and the tuned conventional antenna in the frequency range; and

FIG. 5 is a table to illustrate antenna gains of the preferred embodiment and the conventional antenna.

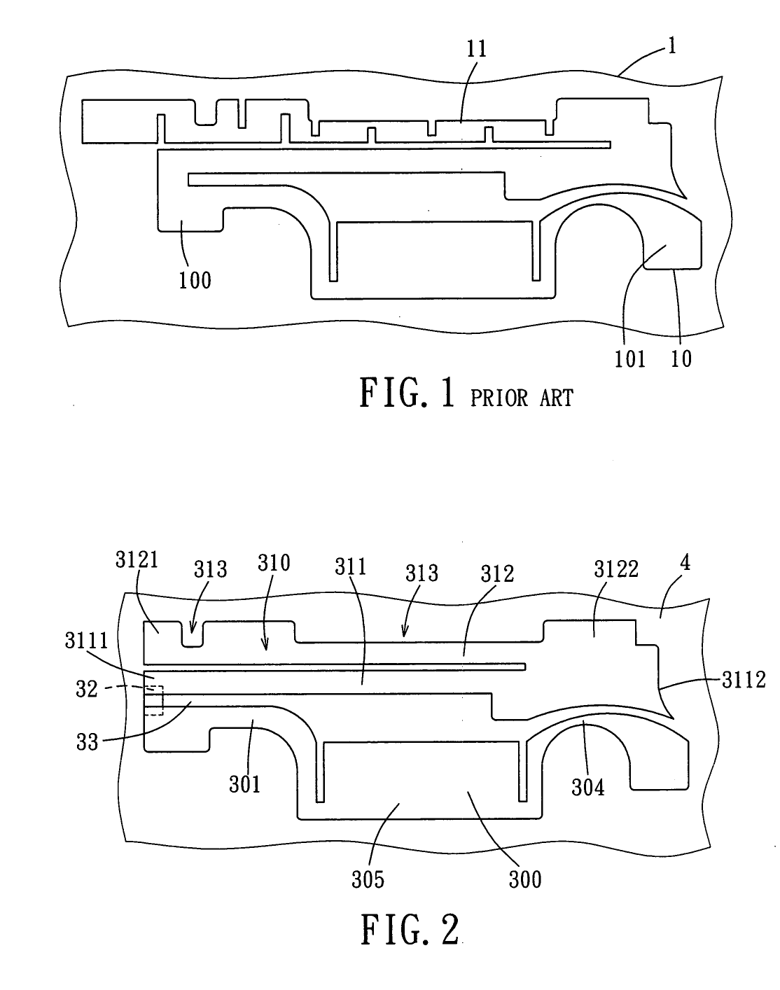

### DETAILED DESCRIPTION OF THE PREFERRED EMBODIMENT

Referring to FIG. 2, the preferred embodiment of anantenn aaccording to this invention is shown to include a loop antenna member 300, a single-pole antenna member 310, and an inductor 32.

The antenna of this embodiment is applicable to a clamshell-type mobile phone (not shown).

The antenna further includes a substrate 4 that has a surface. The loop antenna member 300 and the single-pole antenna member 310 are formed on the surface of the substrate 4 and are made from a copper foil provided in the surface of the substrate 4.

The loop antenna member 300 has curved first and second end portions 301, 304, and a rectangular middle portion 305 that extends between the first and second end portions 301, 304 of the loop antenna member 300. The first end portion 301 of the loop antenna member 300 serves as a feeding terminal that receives a signal, which is to be transmitted, from a source (not shown). On the other hand, the second end portion 304 of the loop antenna member 300 serves as a grounding terminal that is connected to an electrical ground (not shown) which is provided on a circuit board (not shown).

The single-pole antenna member 310 is spaced apart from the loop antenna member 300. As such, a gap 33 exists between the loop antenna member 300 and the single-pole antenna member 310. In this embodiment, the single-pole antenna member 310 has first and second segments 311, 312, each of which has first and second end portions 3111, 3121, 3112, 3122.

The second end portion 3112, 3122 of each of the first and second segments 311, 312 of the single-pole antenna member 310 has a larger area than that of the first end portion 3111, 3121 of a respective one of the first and second segments 311, 312 of the single-pole antenna member 310. The second end portion 3112 of the first segment 311 of the single-pole antenna member 310 extends and turns from the second end portion 3122 of the second segment 312 of the single-pole antenna member 310. As a result, the first and second segments 311, 312 of the single-pole antenna member 310 are respectively proximate to and distal from the loop antenna member 300.

In this embodiment, the second segment 312 of the single-pole antenna member 310 is formed with two notches 313 to thereby increase a resonant wavelength of the antenna of this invention. In an alternative embodiment, the second segment 312 of the single-pole antenna member 310 may be formed with more than two notches.

Although the single-pole antenna member 310 includes only the first and second segments 311, 312, it should be apparent to those skilled in the art that the number of segments may be increased as required.

The inductor 32 has a first inductor terminal connected to the first end portion 301 of the loop antenna member 300, and a second inductor terminal connected to the first end portion 3111 of the first segment 311 of the single-pole antenna member 310. In this embodiment, the inductor 32 is in a form of a semiconductor chip or a 0402 type inductor.

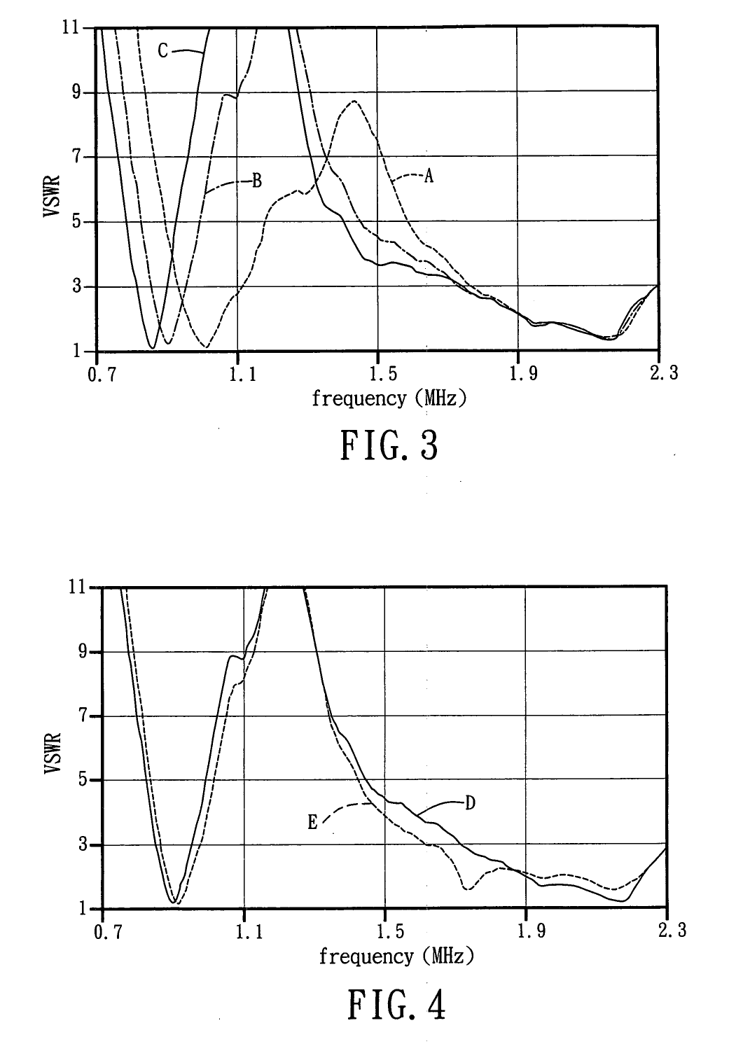

Referring to FIG. 3, the voltage standing wave ratio (VSWR) of the preferred embodiment and the conventional antenna in a frequency range from 0.7 GHz to 2.3 GHz are shown. Based from experimental results, as illustrated in FIG. 3, the VSWR of the antenna of this invention with the inductors 32 having inductances of 5.6 nH and 8.2 nH are designated by lines B and C respectively. It is noted that the conventional antenna (not shown) is dispensed with the inductor 32 and has the loop antenna member thereof directly connected to the single-pole antenna member thereof. The VSWR of the conventional antenna is designated by line A in FIG. 3. It can be deduced from these results that the resonance frequency of the antenna of this invention will be tuned to a lower specific band by increasing the inductance of the inductor 32. Thus a desired resonance frequency, such as the resonance frequency of GSM, in the lower portion of the frequency range of the antenna of this invention may be achieved by simply adjusting the inductance of the inductor 32.

Moreover, as illustrated in FIG. 4, the VSWR of the preferred embodiment and the tuned conventional antenna are designated by lines D and E respectively. The conventional antenna has been tuned such that the lower resonance frequency is tuned to the GSM band. But the tuned conventional antenna also produces one more resonance by a second harmonic in the higher portion, such as the DCS (1800 MHz) band, of the frequency range.

In contrast, the performance of the antenna of this invention does not be deteriorated by the second harmonic since the signal path of the single-pole antenna member 310 is shorter by the inductor 32 and the second harmonic is over the frequency range.

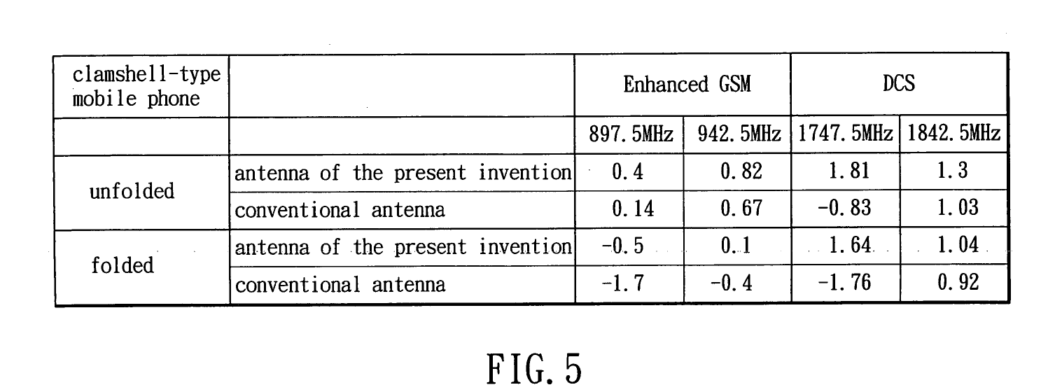

Further, as illustrated in FIG. 5, when operated within the GSM900 bandwidth and the DCS1800 bandwidth, the antenna of this invention has antenna gains that are higher than those of the conventional antenna regardless of whether the clamshell-type mobile phone (not shown) to which the antenna is applied is folded or unfolded. The gain of the antenna of this invention is higher than those of the conventional antenna about 2.5˜3 dB since the longer signal path of the conventional antenna attenuates the gain thereof.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna, comprising:
a loop antenna member;
a single-pole antenna member spaced apart from said loop antenna member; and
an inductor having a first inductor terminal coupled to said loop antenna member, and a second inductor terminal coupled to said single-pole antenna member.

2. The antenna as claimed in claim 1, further comprising a substrate, said loop antenna member being made from a copper foil provided on said substrate.

3. The antenna as claimed in claim 2, wherein said loop antenna member has curved first and second end portions, and a rectangular middle portion extending between said first and second end portions.

4. The antenna as claimed in claim 1, further comprising a substrate, said single-pole antenna member being made from a copper foil provided on said substrate.

5. The antenna as claimed in claim 4, wherein said single-pole antenna member has first and second segments, each of which has first and second end portions, said second end portion of said first segment of said single-pole antenna member extending and turning from said second end portion of said second segment of said single-pole antenna member.

6. The antenna as claimed in claim 5, wherein said first and second segments of said single-pole antenna member are respectively proximate to and distal from said loop antenna member, said second segment of said single-pole antenna member being formed with a plurality of notches.

7. The antenna as claimed in claim 6, wherein said loop antenna member is made from a copper foil provide on said substrate and has curves first and second end portions, and a rectangular middle portion extending between said first and second end portions.

8. The antenna as claimed in claim 7, wherein said first and second inductor terminals of said inductor are coupled respectively to said first end portion of said loop antenna member, and said first end portion of said first segment of said single-pole antenna member.

9. The antenna as claimed in claim 1, wherein said inductor is a 0402 type inductor.
